(19) United States
(12) Patent Application Publication
(10) Pub. No.: US 2008/0200297 A1
(43) Pub. Date: Aug. 21, 2008

(54) Simple bicycle drive shaft transmission

(76) Inventor: Terry Luke Hahn, Edmonton (CA)

Correspondence Address: TERRY HAHN, 474-21 10405 JASPER AV., EDMONTON, AB, T5J 3S2, omitted

(21) Appl. No.: 11/706,306

(22) Filed: Feb. 15, 2007

(51) Int. Cl. F16H 9/26

(52) U.S. Cl. 475/182

(57) ABSTRACT

This transmission (24 and 26) operates by use of a drive shaft (18 and 20), that by being extendible and retractable, can vary in length. Gears on each end of the drive shaft deliver power from one of a number of concentric rings of gear teeth on a pedal gear (12) to a similar arrangement on a wheel gear (14). The pinion gear (16), at the end of each drive shaft half, by moving between these concentric rings, can vary the gear ratios of the power delivered. A cam mechanism (40) is employed to change the length of the drive shaft and especially, guide the lift of the drive shaft pinion gear off of the one ring gear as it disengages and the setting it down to engage the next of the concentric ring gears. A separate, but synchronized cam mechanism (42) is also used to hold the pinion and ring gears in mesh, and to release the pinion gear during changing. An alternative method to the use of a cam, that performs the same function using a track (60) and a trolley (62) is also described. These mechanisms allow a radial taper to all gears plus full and stable meshing of the gears.

### BACKGROUND OF THE INVENTION

This invention relates to bicycle transmissions. A means for transferring power from the pedal crankshaft, to the rear wheel, that is adjustable to provide different gear ratios, has been improved upon by this invention.

This invention would be classified under “Machine Element or Mechanism” (74), subsection “Transmissions under Longitudinally slidable in which there is a single slidable bevel gear in mesh with a toothed disk, or one of a plurality of bevel gears for changing the speed” (350) and also, under “Land Vehicles” (280), subsection “Reversing and power ratio change (236).

Prior art dates back as far as 1899 when Greiner (U.S. Pat. No. 623,780) described a drive shaft bicycle that employed bevel gears, engaging other bevel gears having a variety of radiuses, on a pedal crankshaft. This design gave a sure transmission of power at different ratios, but required loosening of a bolt and a manual change of the ratio. Since Greiner in 1899, the focus of improving this most efficient of designs has been in improving the manner of shifting between gears. In 1945 Hussey (U.S. Pat. No. 2,378,634) described a similar arrangement with the addition of a mechanism to switch between the gear rings without tools. In order for his design to function, the gear teeth had to pass thru each other when gears were changed. In 2000 Pogson (U.S. Pat. No. 6,155,127) patented a design that attempted to shift gears on the fly and use bevel gearing. As with Hussey's design, gear teeth that are closer together close to the center, than they are farther to the outside (radial), have to somehow slide over each other. This must make changing gears next to impossible. This design lacks a positive method of lifting the bevel gears on and off each other when engaging and disengaging. It relies solely on the front and back angles of the bevel gears to slide over each other. It also limits the force that can be exerted to hold the gear surfaces together, which can allow gear slippage. The casings, which are integral to the design also add weight to the bicycle. The drive shaft is bent in the middle causing unnecessary weight and friction from the change of direction of the rotational force. The above are possibly the best examples of the prior art, which is crowded with many examples of complexity, with attendant added mass, power loss, expense of manufacture, and increased probability of breakdown. Worth mention is the present most commonly used system employing a derailleur system, that uses the flexibility of a chain drive to shift between different sized sprockets at the pedal crankshaft and drive wheel. These devices tend to be imprecise and unreliable. Often, the chain falls off the sprockets entirely. Much of the prior art refers to itself as a chainless bicycle.

### BRIEF SUMMARY OF THE INVENTION

The object of this invention is to provide the most efficient and effective means possible to vary the gear ratio of power delivery from a pedal crankshaft to a drive wheel.

This invention provides a new method of engaging and disengaging a pinion gear at each end of the drive shaft onto and off of the concentric rings of bevel gears at the pedal crankshaft and/or at the driven wheel hub. The new method employed is to lift the drive shaft gear off of one ring of gears, move it over, and to set it down onto another ring of gears.

Once the gearing is engaged, the only components of the transmission that move are the pedal gear, the drive shaft, the spring and the drive gear. There is no casing integral to the design. The pedal gear can face in, to keep loose clothing safe and clean. The drive shaft is held in a straight line between the two end gears, by the transmission. Shifting is precise and easy because the drive shaft is lifted out of engagement, and set back down into engagement. The radial bevel of the gears no longer causes a problem in shifting. In addition, this design holds the gears in solid engagement before and after the shifting action.

### BRIEF DESCRIPTION OF THE SEVERAL VIEWS OF THE DRAWING

FIG. 1 is a side view of the overall mechanism of the drive train.

FIG. 2 is a detailed view of the transmission.

FIG. 3A shows where the cross section for FIG. 3B is taken from.

FIG. 3B is a top cross sectional view featuring the shift cam and also showing the cradle cam.

FIG. 4 is a top view of an alternate implementation.

### REFERENCE NUMBERS

12 pedal gears

14 wheel gears

16 pinion gear

18 drive shaft (pedal half)

20 drive shaft (wheel half)

22 transmission engagement notches

24 transmission (pedal end)

26 transmission (wheel end)

28 spring

40 shift cam

42 cradle cam

44 synchronizing key

46 cradle shaft

48 top support

50 cradle

52 control cable

54 frame pin

56 bottom support

60 track

62 trolley

64 drive shaft support

70 bicycle frame

### DESCRIPTION OF THE INVENTION

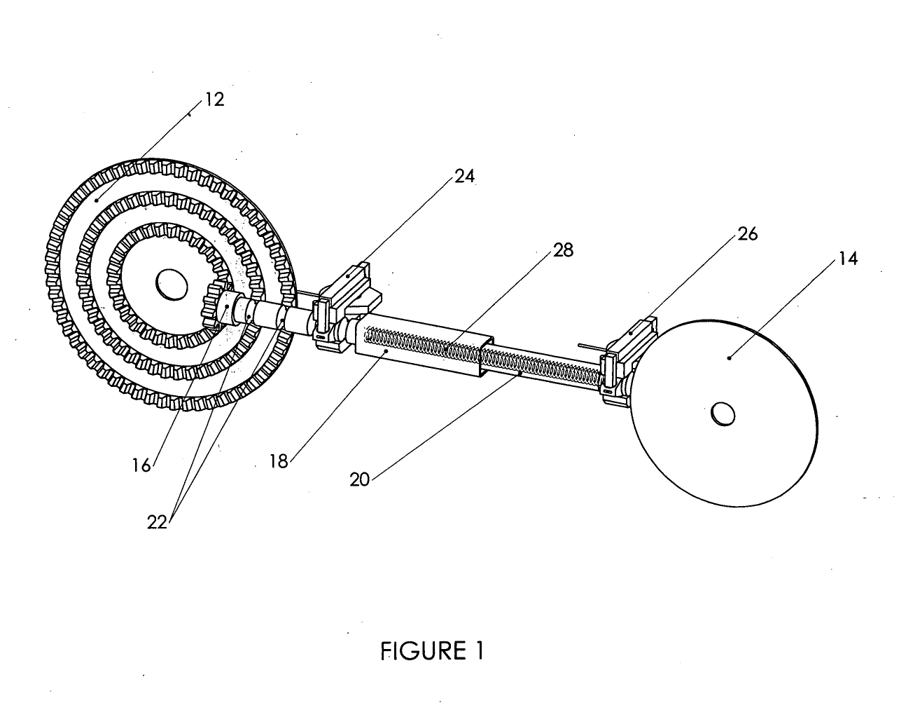

FIG. 1 is a view of the overall mechanism of the drive chain

FIG. 1 shows a drive train that is set up to operate with the drive train transmission in its preferred embodiment. The pedal gears 12 consist of a number of rings of bevel gears concentrically mounted on the same plane and with the same diametral pitch. The wheel gears 14 are a similar arrangement on a smaller scale and facing in the opposite direction from the pedal gears. Each of the pedal gears and the wheel gears operate with a compatible pinion gear 16.

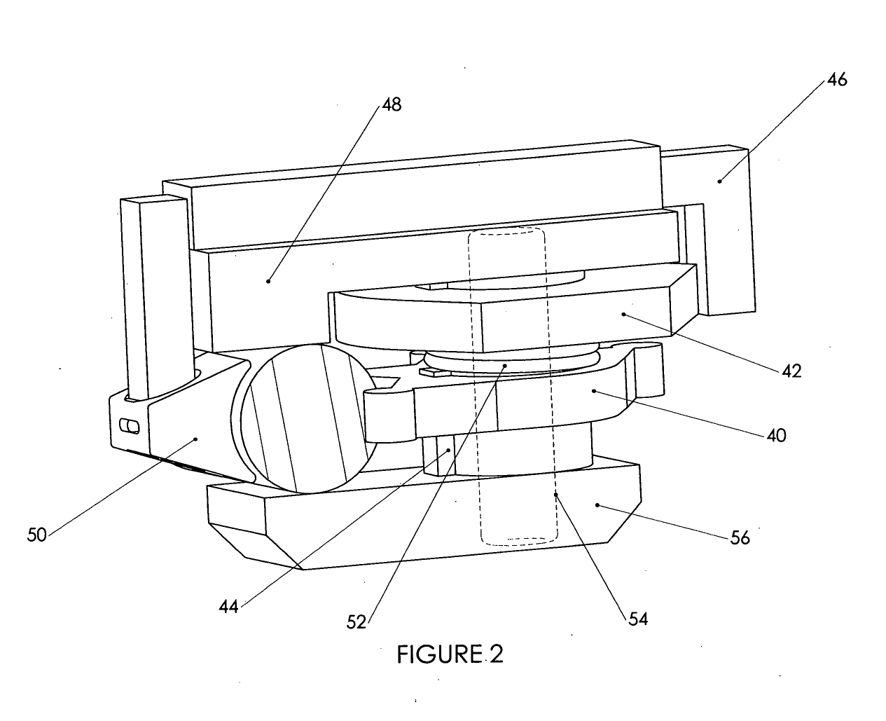

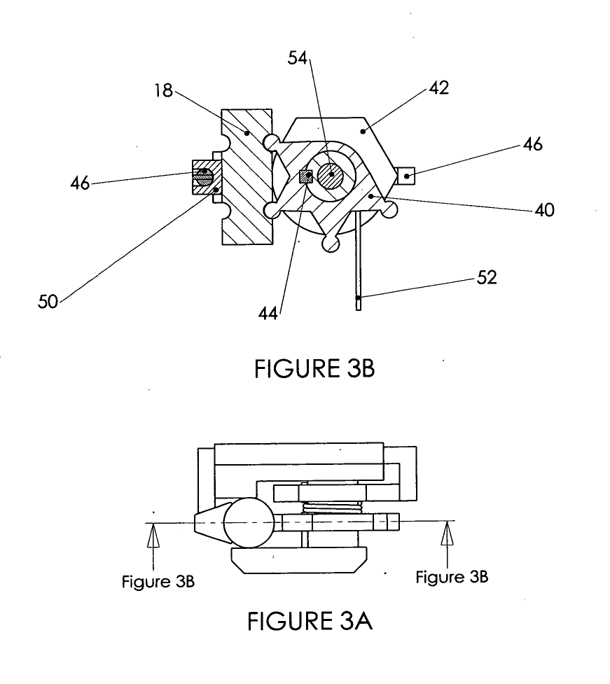

Each pinion gear is attached to a drive shaft 18&20. Each drive shaft half consists of a rod with notches 22 at the end closest to the pinion gear. These notches provide a mechanism for engaging the transmission with the drive shaft, without interfering with the rotational motion of the drive shaft. These notches are the same distance apart as the difference in radius between the corresponding ring gears. The end of each drive shaft half, opposite from the pinion gear end, is constructed of square tubing. The smaller square tube is small enough to allow motion around the axis of rotation of the drive shaft sufficient to allow movement of the pinion gears out of and into engagement with the ring gears. These square tubes enable the drive shaft to retain rotational rigidity and still allow longitudinal movement. The end of the smaller square tube is flared at its end in order to tighten the fit between the square tubes and still allow motion around the longitudinal axis. The drive shaft is forced apart by a spring 28 between the two assembled halves of the drive shaft. The spring is housed inside the square tubes. The spring is opposed by the control cable 52 (FIG. 2,3B,4) via the transmission and the notches. Each half of the drive shaft has its own transmission unit 24&26. Each transmission half operates identically and is shown in detail in FIGS. 2, and 3B.

FIG. 2 is a detailed view of the transmission

FIG. 2 shows a the drive shaft held by the transmission 24 or 26 (FIG. 1) and the transmission is attached to the bicycle frame. Attachment of the transmission to the frame is accomplished with a frame pin 54. The frame pin solidly retains a shaft shelf herein referred to as the bottom support 56, and a cradle and drive shaft support herein referred to as the top support 48. This arrangement acts as a clamp to prevent movement of the drive shaft on the vertical plane.

The shift cam 40 (FIGS. 2&3B) and the cradle cam 42 (FIGS. 2&3B) rotate freely around the frame pin within the constraints imposed by the spring 28 (FIG. 1) and the control cable 52. The shift cam and the cradle cam are supported, and forced to rotate as a unit by the synchronizing key 44. The synchronizing key rotates freely around the frame pin and centers the shift cam and the cradle cam. The shift cam lobes have a cylindrical shape designed to fit into the drive shaft notches. This design allows the shift cam to engage the drive shaft notches 22.

The cradle cam operates the cradle shaft 46 which is attached to the cradle 50. The cradle cam releases the drive shaft during gear change, and then secures the drive shaft again when the shifting operation is complete. This is why the shift cam and the cradle cam are locked in synchronization.

FIG. 3A shows where the cross sectional view of FIG. 3B is taken from.

FIG. 3B is a cross sectional view featuring the shift cam and the cradle cam.

When an operator wishes to change gears they use the shift control at the handle bars to reel in or reel out the control cable 52. Reeling in the cable compresses the drive shaft spring 28 and shortens the drive shaft. Reeling out the control cable allows the spring to extend the drive shaft. When one of the transmissions is shifting, all motion occurs at that transmission, as the other transmission has its part of the drive shaft held in place, as each is controlled by its own cable. As can be seen in FIG. 3B when the drive shaft 18 extends, the shift cam 40 rotates around the frame pin 54 and forces the drive shaft outward from the shift cam, as it extends longitudinally, and then allows it back towards the shift cam as the drive shaft comes to rest on the next set of cams. This is the motion that allows the pinion gear 16 to disengage one ring gear and to engage another ring gear of the pedal gears 12.

The cradle cam 42 operates to hold the drive shaft pinion engaged and to release the drive shaft during the shifting process. When the drive shaft is at rest, the cradle cam is at its maximum extension. This extended cam forces the cradle 50 against the drive shaft, by way of the cradle shaft 46. When the operator reels out the control cable, the drive shaft extends and rotates the shift cam 40. As the cradle cam is locked rotationally with the shift cam by the synchronizing key 44 they both rotate around the frame pin. As the effective length of the cam lobe decreases, it releases the cradle, by way of the cradle shaft and allows the shift cam to force the drive shaft away from it. As the drive shaft returns to engage the said gears, the cradle cam simultaneously reaches its maximum extension and again the drive shaft is held to keep the engaged gears in place. When the control cable is reeled in, the operation simply reverses direction. It should be noted that the cradle 50 must be able to rotate around the cradle shaft 46 to allow for the angle away from the longitudinal axis of the drive shaft that occurs during the shifting process.

The transmission at the pedal end 24 works in the same manner as the transmission at the wheel end 26.

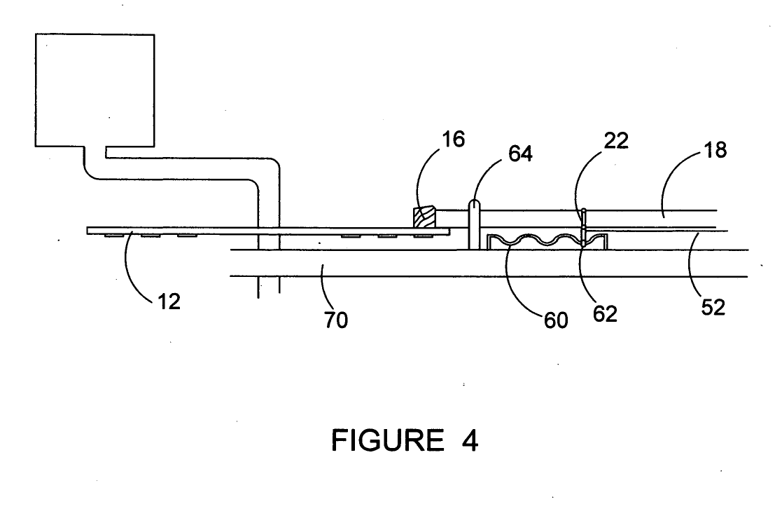

FIG. 4 is a top view of an alternate implementation.

Another way to change gears by lifting the drive shaft pinion gear 16 off one gear ring and setting it down onto another gear ring, would be a linear implementation (FIG. 4). One way shown to accomplish this is by using a trolley 62 that is pulled forward or back by a control cable 52 in opposition to a spring 28 (FIG. 1). This trolley is connected to the drive shaft 18 by a ring or doughnut that fits the notch 22 in the drive shaft into which it protrudes and is held onto a track 60 by another ring so that when the gears are engaged, they are held together. The drive shaft must be free to rotate unhindered, and also the trolley must be able to lift and lower the drive shaft, and extend and retract the drive shaft length. The trolley rolls on the track which is connected to the frame 70. The drive shaft is held from moving in a vertical direction by a slotted mechanism 64 that allows room for the gear changing motion. The track approximates the surface of the pedal gear 12 for changing gears at the pedal, and approximates the surface of the wheel gear for changing gears at the drive wheel. When the trolley is pulled over the hills and valleys of the track (by the cable in opposition to the spring), said trolley lifts the pinion gear from the ring gear as the drive shaft extends or retracts and then holds the pinion gear onto the next ring gear to end the shifting operation.

All parts of the transmission that hold the drive shaft, would benefit from the use of bearings and lubrication to limit the effects of friction.

With respect to the above description, it is realized that the optimum dimensional relationships for the parts of the invention, including variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The foregoing is considered as illustrative only of the principles of the invention. Since numerous modifications and changes are possible to a skilled artisan, it is undesirable to limit the invention to the exact construction shown.

What I claim as my invention is:

1) A gear change mechanism for moving a pinion gear between concentric rings of gears of different radii, comprising
a) a cam
whereby said cam guides the lift, extension or retraction, and setting down of said pinion gear, to disengage one ring gear, and engage another ring gear.

2) The cam of claim 1 wherein said cam has lobes that terminate in a shape suitable for engaging the drive shaft notches cut around the drive shaft.

3) A gear change mechanism for moving a pinion gear between concentric rings of gears of different radii, comprising
a) a cam
whereby said cam holds said pinion gear in mesh, and releases said pinion gear during the shift operation.

4) A gear change mechanism for moving a pinion gear between concentric rings of gears of different radii, comprising
a) a track and
b) a trolley
whereby said track guides said trolley, in order to guide the lift, extension or retraction, and setting down of said pinion gear, to disengage one ring gear, and engage another ring gear.
